(19) United States
(12) Patent Application Publication
(10) Pub. No.: US 2019/0387488 A1
(43) Pub. Date: Dec. 19, 2019

(54) METHOD FOR INDICATING TIME INDEX, TIMING ACQUISITION METHOD, APPARATUSES THEREOF AND COMMUNICATION SYSTEM

(71) Applicant: FUJITSU LIMITED, Kawasaki-shi (JP)

(72) Inventors: Xin WANG, Beijing (CN); Qinyan JIANG, Beijing (CN)

(73) Assignee: FUJITSU LIMITED, Kawasaki-shi (JP)

(21) Appl. No.: 16/555,335

(22) Filed: Aug. 29, 2019

Related U.S. Application Data
(63) Continuation of application No. PCT/CN2017/083305, filed on May 5, 2017.

(51) Int. Cl. H04W 56/00; H04W 72/00; H04W 72/04; H04L 5/10; H04L 5/00

(52) U.S. Cl. CPC H04W 56/005; H04W 72/005; H04L 5/0051; H04L 5/10; H04W 72/0446

(57) ABSTRACT

A method for indicating a time index of a synchronization signal block and timing acquisition method and apparatuses thereof and communication system. The method for indicating a time index of a synchronization signal block includes: a time index of an SS block is indicated by using physical broadcast channel demodulation reference signals (PBCH DMRSs) within a bandwidth of a synchronization signal, the SS block comprising a primary synchronization signal, a secondary synchronization signal and a physical broadcast channel. By indicating the time index of the SS block by using the method of this embodiment, the terminal equipment may be enabled to obtain needed timing information.

### CROSS REFERENCE TO RELATED APPLICATIONS

This application is a continuation application of International Application No. PCT/CN2017/083305, filed on May 5, 2017, the entire contents, are incorporated herein by reference.

### FIELD

This disclosure relates to the field of communications, and in particular to a method for indicating time index of a synchronization signal block in new radio system, a timing acquisition method, apparatuses thereof and a communication system.

### BACKGROUND

In new radio (NR) standards of fifth generation (5G) mobile communication systems, support of single beam and multi-beam and consistent design are taken into account in designing synchronization signals. To this end, a concept of a synchronization signal block, hereinafter referred to simply as an SS block or SSB, is introduced. No matter a single beam or multi-beam, each SS block contains a primary synchronization signal (referred to as a PSS or an NR-PSS in brief), a secondary synchronization signal (referred to as an SSS or an NR-SSS in brief) and/or a physical broadcast channel (referred to as a PBCH or an NR-PBCH in brief).

It is defined in the NR standards that one or more synchronization signal blocks (SS blocks) constitute a synchronization signal burst (an SS burst), and one or more SS bursts form a synchronization signal burst set (SS burst set). A period of an SS burst set may be defined, or may be configurable.

For an SS block, a manner of beam sweeping is used, that is the SS block is transmitted repeatedly in different time units so that the SS block may be received by a user equipment (UE) within a cell. A resulting problem is that unlike a long term evolution (LTE) system, frame timing cannot be obtained simply by PSS and SSS detection. As in a certain time unit, such as an SS burst set period, or a frame, or a sub-frame, or even a slot, or a mini-slot, or the like, there may exist multiple SS blocks, it is needed to indicate which SS block it is, i.e. a time index, so as to obtain timing information of the SS burst set, or obtain other timing information, such as information on SS block timing, SS burst timing, frame timing and associated symbol timing, and slot/mini-slot timing, etc., by using the time index.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that a time index of an SS block may be indicated by information carried by a PBCH, but according to synchronization signal parameters determined according to the progress of current NR standardization, the indication by the information carried by the PBCH may possibly be hard to be carried out. Particularly, since a TTI of the PBCH is 80 ms, it means that a master information block (MIB) carried by it cannot be changed during this period. And a period of an SS burst set is 20 ms, and the number of SS blocks contained therein is at most 64. In this way, if the PBCH must be used to carry, it may only carry implicitly, which will result in a large number of PBCH blind detection, and a UE is difficult to implement. Furthermore, as sequence lengths of an NR-PSS and an NR-SSS are both 127, and a bandwidth of an NR-PBCH is 288. That is, a bandwidth of a synchronization signal defined in the NR standards is only half the bandwidth of the PBCH. For a terminal device, in a process of searching a synchronization signal, such as cell search, or cell selection, of neighboring cell, etc., in order to reduce processing complexity, reduce memory and ensure performance, a low-pass filter is often used to filter out signals out of a bandwidth of the synchronization signal, perform synchronization signal capture on narrow-band signals thus obtained, and directly perform synchronization measurement on the narrow-band signals after obtaining synchronization needed by the measurement. Thus, half of signals of the PBCH may be filtered out, and the remaining part of the PBCH cannot recover its transmission information and cannot indicate the time index of the SS block, hence, the measurement cannot be completed quickly and with low complexity.

In order to solve the above problems, embodiments of this disclosure provide a method for indicating time index, a timing acquisition method, apparatuses thereof and a communication system.

According to a first aspect of the embodiments of this disclosure, there is provided a method for indicating a time index of a synchronization signal block, including:

a time index of an SS block is indicated by using new radio physical broadcast channel demodulation reference signals (NR-PBCH DMRSs) within a bandwidth of a synchronization signal, the SS block including a primary synchronization signal, a secondary synchronization signal and a physical broadcast channel.

According to a second aspect of the embodiments of this disclosure, there is provided a timing acquisition method, including:

an SS block is receivied, the SS block including a primary synchronization signal, a secondary synchronization signal and a physical broadcast channel;

a time index of the SS block is acquired according to new radio physical broadcast channel demodulation reference signals (NR-PBCH DMRSs) within a bandwidth of a synchronization signal; and

needed timing information is acquired according to the time index of the SS block.

According to a third aspect of the embodiments of this disclosure, there is provided an apparatus for indicating a time index of a synchronization signal block, including:

an indicating unit configured to indicate a time index of an SS block by using new radio physical broadcast channel demodulation reference signals (NR-PBCH DMRSs) within a bandwidth of a synchronization signal, the SS block including a primary synchronization signal, a secondary synchronization signal and a physical broadcast channel.

According to a fourth aspect of the embodiments of this disclosure, there is provided a timing acquisition apparatus, including:

a receiving unit configured to receive an SS block, the SS block including a primary synchronization signal, a secondary synchronization signal and a physical broadcast channel; and

an acquiring unit configured to acquire a time index of the SS block according to new radio physical broadcast channel demodulation reference signals (NR-PBCH DMRSs) within a bandwidth of a synchronization signal, and acquire needed timing information according to the time index of the SS block.

According to a fifth aspect of the embodiments of this disclosure, there is provided a network device, including the apparatus as described in the third aspect.

According to a sixth aspect of the embodiments of this disclosure, there is provided a terminal equipment, including the apparatus as described in the fourth aspect.

According to a seventh aspect of the embodiments of this disclosure, there is provided a communication system, including the network device as described in the fifth aspect and the terminal equipment as described in the sixth aspect.

According to an eighth aspect of the embodiments of this disclosure, there is provided a computer readable program, which, when executed in an apparatus for indicating a time index of a synchronization signal block or a network device, will cause the apparatus for indicating a time index of a synchronization signal block or the network device to carry out the method for indicating a time index of a synchronization signal block as described in the first aspect.

According to a ninth aspect of the embodiments of this disclosure, there is provided a computer readable medium, including a computer readable program, which will cause an apparatus for indicating a time index of a synchronization signal block or a network device to carry out the method for indicating a time index of a synchronization signal block as described in the first aspect.

According to a tenth aspect of the embodiments of this disclosure, there is provided a computer readable program, which, when executed in a timing acquisition apparatus or a terminal equipment, will cause the timing acquisition apparatus or the terminal equipment to carry out the timing acquisition method as described in the second aspect.

According to an eleventh aspect of the embodiments of this disclosure, there is provided a computer readable medium, including a computer readable program, which will cause a timing acquisition apparatus or a terminal equipment to carry out the timing acquisition method as described in the second aspect.

An advantage of the embodiments of this disclosure exists in that with the embodiments of this disclosure, the terminal equipment may be enabled to acquire needed timing information, such as SS burst timing, SS burst set timing, symbol timing, mini-slot timing, slot timing, or frame timing.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals assign corresponding parts throughout the several views and may be used to assign like or similar parts in more than one embodiment.

The drawings are included to provide further understanding of this disclosure, which constitute a part of the specification and illustrate the exemplary embodiments of this disclosure, and are used for setting forth the principles of this disclosure together with the description. It is clear and understood that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of an embodiment of this disclosure;

FIG. 2 is a schematic diagram of an SS burst set;

FIGS. 3A, 3B and 3C are a schematic diagram of an SS block;

FIG. 4 is a schematic diagram of a filtering result of an SS block by a filter;

FIG. 5 is a schematic diagram of the method for indicating a time index of a synchronization signal block of Embodiment 1;

FIG. 6 is a schematic diagram of a PBCH-DMRS within a bandwidth of a synchronization signal;

FIG. 7 is a schematic diagram of an RB containing two paired DMRSs;

FIG. 8 is a schematic diagram of shift of a position of the DMRS according to a cell identifier;

FIG. 9 is a schematic diagram of the timing acquisition method of Embodiment 2;

FIG. 10 is a schematic diagram of the apparatus for indicating a time index of a synchronization signal block of Embodiment 3;

FIG. 11 is a schematic diagram of the timing acquisition apparatus of Embodiment 4;

FIG. 12 is a schematic diagram of the network device of Embodiment 5; and

FIG. 13 is a schematic diagram of the terminal equipment of Embodiment 6.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. The embodiments of this disclosure shall be described below with reference to the accompanying drawings. These embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G 2.5G 2.75G 3G 4G 4.5G and 5G and new radio (NR) in the future, etc., and/or other communication protocols that are currently known or will be developed in the future.

In the embodiments of this disclosure, the term “network device”, for example, refers to a device in a communication system that accesses terminal equipment to the communication network and provides services for the terminal equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Scenarios in the embodiments of this disclosure shall be described below by way of examples; however, this disclosure is not limited thereto.

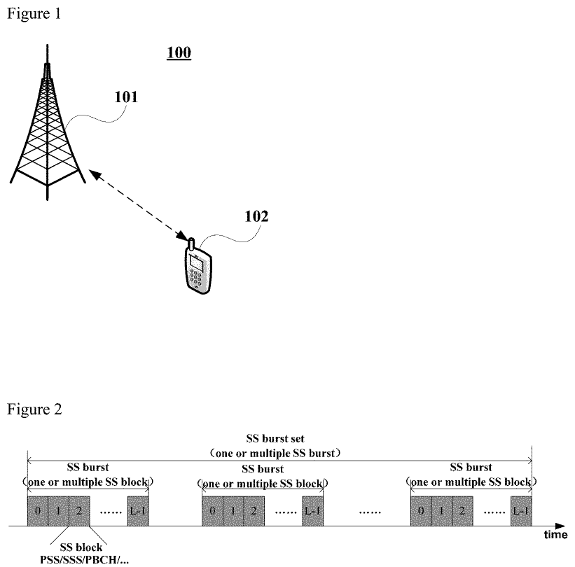

FIG. 1 is a schematic diagram of a communication system of an embodiment of this disclosure, in which a case where a user equipment and a network device are taken as examples is schematically shown. As shown in FIG. 1, the communication system 100 may include a network device 101 and a terminal equipment 102 (for the sake of simplicity, FIG. 1 shall be described by taking only one terminal equipment as an example).

In the embodiment of this disclosure, existing traffics or traffics that may be implemented in the future may be performed between the network device 101 and the terminal equipment 102. For example, such traffics may include but not limited to an enhanced mobile broadband (eMBB), massive machine type communication (mMTC), and ultra-reliable and low-latency communication (URLLC), etc.

The terminal equipment 102 may transmit data to the network device 101, such as in a grant-free transmission mode. The network device 101 may receive data transmitted by one or more terminal equipments 102 and feedback information (e.g. acknowledgement ACK/non-acknowledgement NACK) to the terminal equipment 102. And the terminal equipment 102 may confirm to end the transmission process according to the feedback information, or may further perform new data transmission, or may perform data retransmission.

In order to make the method, apparatus and system of the embodiments of this disclosure easy to be understood, concepts, consensuses, configuration, and/or assumptions concerned in the embodiments of this disclosure shall be described below with reference to the accompanying drawings; however, it will be appreciated to those skilled in the art that the embodiments of this disclosure are not limited to the following consensuses, configuration, and/or assumptions, and any applicable scenarios are contained in the scope of this application.

A synchronization signal defined in the NR standards is based on cyclic prefix-orthogonal frequency division multiplexing (CP-OFDM), and similar to LTE systems, NR-PSS and NR-SSS are also defined. What is different from the LTE systems is that related frequency bands including those lower than 6 GHz and above 6 GHz are employed in the NR standards, and bandwidths thereof may also be wider. Compared with the LTE systems, in the NR standards, the bandwidth of the synchronization signal is increased, and at the same time, single-beam and multi-beam scenarios need to be supported. And designs of subcarrier intervals and the period of the synchronization signal are also more flexibly.

Sequence lengths of the NR-PSS and NR-SSS are both 127, the NR-PSS is transmitted on consecutive 127 subcarriers, and the bandwidth of NR-PBCH is 288 subcarriers. For frequency bands below 6 GHz, the NR-PSS and NR-SSS may employ a sub-carrier interval of 15 kHz or 30 kHz; and for frequency bands above 6 GHz, the NR-PSS and NR-SSS may employ a sub-carrier interval of 120 kHz or 240 kHz. And the numerologies of the NR-PBCH, NR-PSS and NR-SSS are identical.

In order to maintain a consistent design in the single-beam and multi-beam scenarios, concepts of a synchronization signal block (SS block), a synchronization signal burst (SS burst) and a synchronization signal burst set (SS burst set) are given in the NR standards. An SS block contains a NR-PSS, an NR-SSS and an NR-PBCH, which are combined in a time division multiplexing (TDM) mode. One or more SS blocks constitute an SS burst, and one or more SS bursts constitute an SS burst set, as shown in FIG. 2.

The purpose of such definition is that support for multi-beams is taken into account. At a high frequency band above 6 GHz (such as 6 GHz 52.6 GHz), in order to ensure cell coverage, a multi-antenna configuration of a network device needs to be borrowed, that is a beam sweeping mode is adopted to enhance coverage. For a synchronization signal, the use of beam sweeping means that the synchronization signal is repeatedly transmitted by using different beams at different time units, so that terminal equipments at different locations in the cell may be covered by beams containing the synchronization signal. It should be noted that since there may be only one SS block in one SS burst, and there may be only one SS burst in one SS burst set, a single beam may be implicitly supported in such a definition manner.

According to the current progress of the NR standardization, the number of SS blocks in an SS burst set is within 4 for a case where carrier frequencies are less than 3 GHz; the number of SS blocks in an SS burst set is within 8 for a case where carrier frequencies are 3 GHz to 6 GHz; and the number of SS blocks in an SS burst set is within 64 for a case where carrier frequencies are above 6 GHz (such as 6 GHz to 52.6 GHz). For initial cell search, a default period of an SS burst set is 20 ms, for a connected mode or idle mode or non-stand-alone (NSA) scenario, a period of an SS burst set may be 5 ms, 10 ms, 20 ms, 40 ms, 80 ms, or 160 ms. In this case, in order to increase flexibility of the system, although the maximum number of SS blocks is specified for the system, the number of transmissions is variable. However, how many SS blocks are finally transmitted in an SS burst set and locations of these SS blocks may be notified by the network to a terminal. That is, a time position of each SS block is consistently known to the network side and the user side, that is, this period is configurable.

It should be noted that as to the time index of the SS blocks in the NR referred to herein, their particular forms have not been specifically defined in the NR. For an SS burst set, if there are up to 64 SS blocks in it, the time index may correspond to a sequence number of an SS block which is transmitted, such as a 6th SS block, a 33th SS block, or a 62th SS block. It may also be indicated by a 2-step indexing method, for example, an SS burst set contains up to four SS bursts, and each SS burst contains up to 16 SS blocks, then the time index may be used to mark which SS block in which SS burst. It is also possible to use other manners to mark the time position information of the SS block in the SS burst set, or mark the time position information of the SS block in the SS burst, and the time position information of the SS burst in the SS burst set may also be inferred.

In summary, the time position information of the SS block, the SS burst and the SS burst set in the NR system is defined in the standards, and even in a case where the period of the SS burst set and transmission of the SS blocks are configurable, relevant information may be communicated between the network and the terminal in advance. That is, it is ensured that after the terminal detects an SS block, timing information, such as SS block timing, SS burst timing, SS burst set timing, and symbol timing, mini-slot timing, slot timing, or frame timing to which the SS block corresponds, may be inferred from the time index attached thereto. And which timing is particularly inferred is determined by the terminal as demanded.

For the convenience of description, form of time index is not differentiated in the embodiments of this disclosure, and the methods of the embodiments of this disclosure shall be described from a viewpoint of identifying different time indices.

From the viewpoint of the terminal equipment, the terminal equipment may capture a PSS in a cell search process, detect an SSS, and further deduce a cell ID, or may also obtain timing information of a symbol level, or even slot timing. However, due to existence of multiple SS blocks, it is impossible to obtain a timing message of an SS burst set via detection of a synchronization symbol. A manner of indicating time index of an SS block needs to be taken into account, so as to obtain the timing message of the SS burst set, and needed timing information, such as symbol timing, mini-slot timing, slot timing, SS burst timing, frame timing, and the like, may be inferred therefrom. It should be noted that no matter an SS burst set configured in a default manner or an SS burst set configuration in a connected status or idle status, the terminal equipment and the network device definitely know positions of time index of an SS block in an SS burst set, and may know an actual transmission situation of SS blocks in an SS burst set via signaling. Thus, after the terminal equipment acquires the time index of the SS block, the timing message of the SS burst set may be deduced, and SS-based measurement of reference signal received power (RSRP) may further be performed. On the other hand, information on the frame timing may usually be deduced, so as to obtain information on a position and sequence of a channel state information reference signal (CSI-RS), thereby performing CSI-RS-based measurement. It should be noted that in some special cases, a mutual timing relationship between the CSI-RS and the SS burst set may be given by the network. And furthermore, as described above, based on the obtained time index, the terminal equipment may also deduce the other needed timing information, such as the symbol timing, mini-slot timing, slot timing, and SS burst timing, etc.

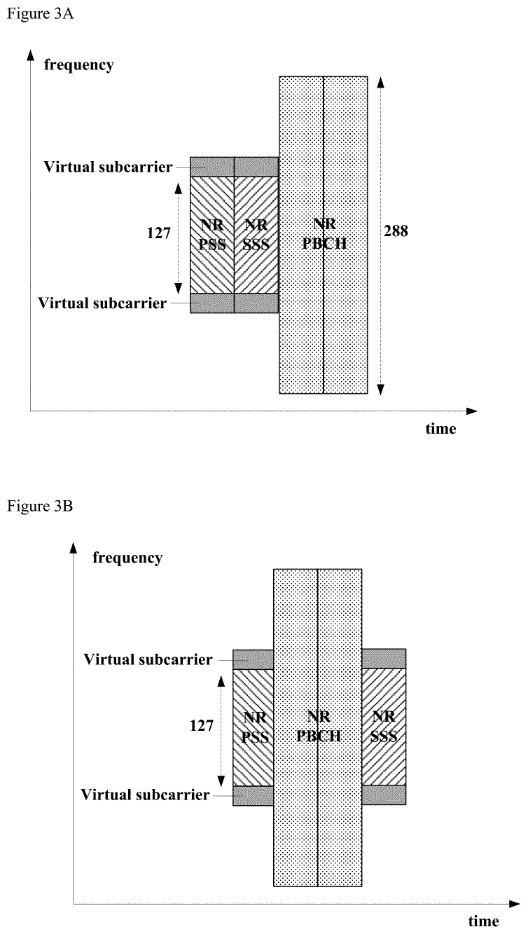

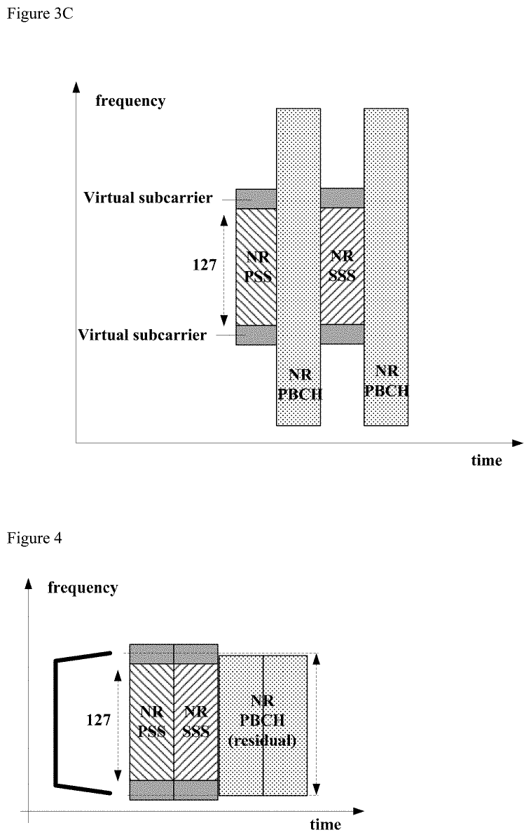

According to current formulation of standards, a typical SS block is shown in FIG. 3, in which one NR-PSS symbol, one NR-SSS symbol, and two NR-PBCH symbols are included. Symbol lengths of the NR-PSS and the NR-SSS correspond to 127 subcarriers, that is, the bandwidth of the synchronization signal is 127 subcarriers. However, if virtual carriers on both sides of the synchronization signal are taken into account, the bandwidth of the synchronization signal is 144 subcarriers, i.e. 12 resource blocks (RBs), while a bandwidth of the PBCH is 288 subcarriers, i.e. 24 RBs. Three multiplexing orders of the NR-PSS, NR-SSS and NR-PBCH in the time domain are shown in FIG. 3, i.e. (a), (b) and (c); however, the embodiments of this disclosure are not limited thereto, and other orders are also applicable. As can be seen from FIG. 3, the NR standards are different from the LTE systems, and the bandwidth of the NR-PBCH is twice as wide as that of the synchronization signal.

In consideration of measurement of mobility, a terminal equipment in a radio resource control (RRC) connected state, or an RRC idle state, or other RRC states, needs to perform cell search and measurement on channel quality of neighboring cells, such as measuring parameters, such as RSRP. For an LTE system, synchronization information such as a cell ID, a CP type, cell frame timing, and the like, may be deduced by detecting the PSS and the SSS, and then sequence information of cell-specific reference signals (CRSs) may be obtained, thereby performing channel quality measurement, such as RSRP, and this process does not need to detect PBCHs of the neighboring cells.

In the standardization of NR, indicating time index of an SS block by a PBCH is discussed. However, as transmission time interval (TTI) of the PBCH is 80 ms and a period of an SS burst set is 20 ms, the maximum number of SS blocks is 64. According to a rule of TTI, master information block (MIB) information in the TTI of 80 ms is constant. Hence, if the PBCH is used to carry time index, a manner of implicitly carrying may only be used. This will result in a large number of PBCH blind detection, and is not feasible for the implementation of the terminal equipment.

On the other hand, in a cell search process, the terminal equipment may use a band-pass filter based on a bandwidth of a synchronization signal, which is usually implemented by a digital domain low-pass filter (LPF) at a baseband, as shown in FIG. 4. It is ensured that a passband corresponds to a synchronization signal sequence of 127 lengths, and a transition band corresponds to virtual carriers on both sides of the synchronization signal sequence. An advantage of this is that detection of a PSS sequence is usually performed in the time domain prior to timing acquisition, and accuracy of the detection of the synchronization signal sequence may only be ensured by filtering out signals out of the bandwidth of the synchronization signal by using an LPF. In order to search for a synchronization signal, a narrow-band signal after the LPF having a length of about an SS burst set may be buffered, and cell search is performed on the signal. For mobility-related cell search, multiple cell IDs may be obtained through measurement and it is desirable to obtain timing information of different Cell IDs, so as to perform channel quality measurement on the cell, such as RSRP measurement. However, as the bandwidth of the synchronization signal sequence and the bandwidth of the PBCH are not consistent, it is impossible to recover contents of the information carried by the PBCH. This also shows that it is not feasible to indicate the time index of the SS block by the information carried by the PBCH.

The method for indicating a time index of a synchronization signal block of the embodiment of this disclosure shall be described below with reference to the accompanying drawings and particular implementations.

### Embodiment 1

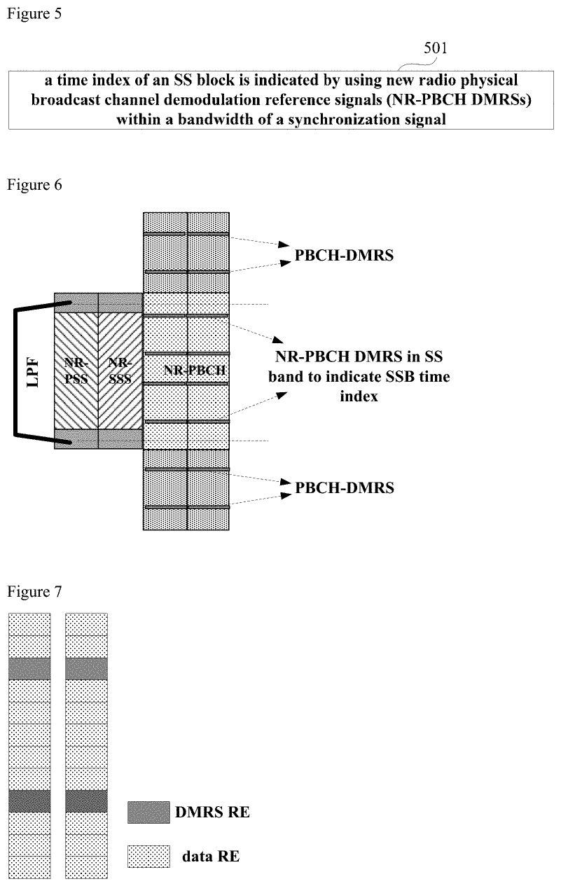

The embodiment of this disclosure provides a method for indicating time index of a synchronization signal block, applicable to a network device in a communication system, such as a gNB defined in the NR standards. FIG. 5 is a schematic diagram of the method. As shown FIG. 5, the method includes:

step 501: a time index of an SS block is indicated by using new radio physical broadcast channel demodulation reference signals (NR-PBCH DMRSs) within a bandwidth of a synchronization signal.

In this embodiment, the SS block includes a primary synchronization signal, a secondary synchronization signal and a physical broadcast channel, which is as described above, and shall not be described herein any further.

In this embodiment, the NR-PBCH DMRSs refer to reference signals within a bandwidth of a PBCH designed to be transmitted together with the PBCH for dealing with the PBCH and adopting the same beam forming and/or precoding mode as the PBCH. The NR-PBCH DMRSs used in step 501 may be DMRSs themselves, or positions where they are located, or new DMRSs obtained after other codewords are superposed on original DMRSs, which are used to indicate the above time index, and shall be further explained in the following implementations.

In this embodiment, as described above, particular form of the time index of the SS block is not limited in this embodiment, which may be a serial number information of the SS block in an SS burst set, or a time position information of the SS block in an SS burst set, or a serial number information of the SS block in an SS burst, or a time position information of the SS blocks in an SS burst, or may be jointly given by the time positions information of the SS block in an SS burst where the SS block is located and a time position information of the SS burst in an SS burst set where the SS burst is located. And SS block timing, SS burst timing, SS burst set timing, frame timing, and related symbol timing, slot timing, and mini-slot timing, etc., may further be acquired from the information on the time index.

For the NR standards, the NR-PSS and the NR-SSS are sequences of a length of 127, which are mapped onto 127 subcarriers. The bandwidth of the NR-PBCH is 288 subcarriers. A subcarrier spacing may be 15 KHz, 30 KHz (for frequency points lower than 6G), or may be 120 KHz, 240 KHz (for frequency points higher than 6G); however, it is not limited thereto, and before acquiring synchronization, in order to detect a synchronization signal, a filter is usually used to filter out other signals than the synchronization signal, so as to ensure accuracy of the synchronization detection process. And furthermore, in consideration from implementation complexity of the terminal equipment, channel quality measurement (such as RSRP) of a synchronized cell or neighboring cells is also performed in a filtered narrowband signal. Thus, the indication scheme of the time index of the SS block given in the embodiment of this disclosure uses only the NR-PBCH DMRSs within a bandwidth of a corresponding synchronization signal.

FIG. 6 gives a schematic diagram of the NR-PBCH DMRSs within the bandwidth of the synchronization signal.

In this embodiment, the bandwidth of the synchronization signal may be a bandwidth to which the synchronization signal corresponds, such as a bandwidth to which 127 subcarriers correspond. If it is defined in the NR standards that an appropriate number of virtual carriers are reserved around a synchronization signal, the bandwidth of the synchronization signal may be a bandwidth of a synchronization signal containing the virtual carriers. For example, for a case where the number of virtual carriers at the two sides is 9, it may also be deemed that the bandwidth of the synchronization signal is a bandwidth to which 12 RBs (144 subcarriers) correspond.

In this embodiment, the method of indicating the time index of the SS block by using the NR-PBCH DMRSs within the bandwidth of the synchronization signal is not limited. The indication method shall be described below by way of several examples; however, this embodiment is not limited thereto.

### Example 1

In this example, the time index of the SS block may be fully or partially indicated by resource element (RE) positions of the NR-PBCH DMRSs within the bandwidth of the synchronization signal. For example, time indices of all SS blocks are indicated, or time indices of a part of the SS blocks are indicated (such as grouping time indices of all SS blocks within each SS bust set, and indicating time indices of each group by this example), and time indices of the other part of the SS blocks or time indices in each group may be indicated in other manners, such as manners contained in other examples, or may be not indicated according to an agreement between the network and the terminal.

In this example, a self-contained mode may be adopted by the NR-PBCH DMRSs, which may be advantageous to flexible configuration of the SS blocks, make channels to be fully utilized, and maintain a good forward compatibility. And furthermore, the DMRSs are of single port signal, and in order that the detection of the DMRSs are more robust to a frequency offset, the DMRSs may be designed as consecutive REs, as shown in FIG. 7. FIG. 7 shows that one RB contains two paired DMRSs, and for 12 RBs within the bandwidth of the synchronization signal, 24 DMRS pairs are totally contained.

In this example, for the design of the DMRSs, accuracy of estimation of channels and a demand for a capacity of indicating the time index are both taken into account, and there are two REs in each RB (12 carriers) for use as DMRSs, a density of the DMRSs being 1/6. As shown in FIG. 7, there are four DMRSs in the 12 carriers of two PBCH symbols.

In this example, for the density of ⅙ of the DMRSs, there may exist six different DMRS RE position sets, and when signals are transmitted, different RE position sets may be employed for different time indices or different time index groups.

For single beam, the number of the SS block is small, and correspondingly, the number of the time index is also limited, such as 4. Hence, the 4 time indices may be indicated by using four DMRS RE position sets. Thus, at a receiver side (such as a terminal equipment), RS sequence match may be performed in all possible DMRS RE position sets by blind detection, and a time index to which a position set with a highest match value is taken as output. And if the number of the time index exceeds 6, the density of the DMRSs may further be lowered, and more DMRS RE position sets may be obtained to perform indication.

For multi-beam, the number of the SS block may be up to 64, and correspondingly, the number of the time index may also be up to 64. Hence, as it is less possible to indicate all the time indices by using DMRS RE position sets, the time indices may be grouped, each group of time indices corresponding to one DMRS RE position set. That is, in this case, the DMRS RE position set can only indicate a group of time indices, i.e. it can only indicate the time indices partially. And indicating all the time indices needs assistance from other means.

For example, for 64 time indices, they may be divided into four groups, each group containing 16 time indices. For example, group number=TimeIdx/4, and a correspondence between each group of indices and the DMRS RE position sets may be:

group#0: TimeIdx={0, 4, 8, 12, 16 . . . }, indicated by DMRSs at position #1;

group#1: TimeIdx={1, 5, 9, 13, 17 . . . }, indicated by DMRSs at position #2;

group#2: TimeIdx={2, 6, 10, 14, 18 . . . }, indicated by DMRSs at position #3;

group#3: TimeIdx={3, 7, 11, 15, 19 . . . }, indicated by DMRSs at position #4.

Thus, by blind detection on the DMRS RE position sets by the receiver, group number of the time index may be obtained, that is, a possible range of the time index is reduced to 16 from 64.

The above mode of grouping is illustrative only, and in particular implementation, grouping may be performed sequentially; for example, 0˜15 are in one group, 16-31 are in one group, 32-47 are in one group, and 48-63 are in one group. In this case, each group may be deemed as corresponding to an SS burst. Four groups correspond to four SS bursts, and each position set indicates an SS burst.

In this example, the grouping mode of the time indices and the correspondence between them and the DMRS RE position sets are not limited. With this example, the time indices of the SS blocks are fully or partially indicated by the RE positions of the NR-PBCH DMRSs within the bandwidth of the synchronization signal, that is, it may be defined in the standards that “Time index could be fully or partially indicated by the position of NR-PBCH DMRS RE in SS band”.

### Example 2

In this example, the time index may be fully or partially indicated by applying a cover code to an original sequence of the NR-PBCH DMRSs, that is, the time indices of SS blocks are fully or partially indicated by the cover code on the NR-PBCH DMRSs within the bandwidth of the synchronization signal. For example, the time indices or the time indices within the same group may be identified by the cover code, and the time indices (fully indicated) or the time indices within the same group (partially indicated) may be indicated by multiplying the original sequence of the DMRSs by the cover code. The cover code here may be an orthogonal code or a non-orthogonal code. And this example may be used in combination with Example 1, or may be used independently.

It is assumed that a sequence format similar to a downlink CRS, a UE-specific RS and a CSI-RS in the LTE system is adopted by the original sequence of the DMRSs:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{NR - PBCH} - 1.$$

N_{RB}^{NR-PBCH} in the above formula is the number of RBs of the NR-PBCH. For the sake of explanation, it is assumed that a density of the DMRSs in each RB is ⅙, and a manner of DMRS pairs is also employed; however, it is not limited thereto. In this example, DMRS sequences of all bandwidths (288 subcarriers, 24 RBs) of the NR-PBCH may be generated by using the above formula, so as to ensure consistence of the design; of course, it is not limited thereto. Moreover, c(i) in the above formula is a pseudo-random sequence, and a cell ID is incorporated into its initial value; however, it is not limited to the following form:

cᵢₙᵢₜ(2N_{ID}^{cell}+1)·2¹⁶

Different from an LTE system, in this example, a factor of a slot number is not introduced into the initial value of the pseudo-random sequence, thereby lowering complexity of detecting the time index of the SS block.

In this example, indicating the time indices of the SS blocks by multiplying the original sequence of the DMRSs by a sequence (i.e. the cover code) identifying different time indices is as follows:

r(m)·cᵢ(m).

Here, the original sequence of the DMRSs is multiplied by the cover code cᵢ(m), different i values denote different cover code sequences, and cover code sequences are orthogonal or approximately orthogonal, that is, <(m)·cⱼ(m)>=0, or, <(m)·cⱼ(m)>≈0; where, i≠j, and <.> denotes an inner product operation.

In this example, a length of a cover code sequence may be identical to the number of DMRSs in a synchronization channel; for example, 12 RBs contain 48 DMRSs, and the length of the cover code sequence is 48. However, this embodiment is not limited thereto, and the length of the cover code sequence may also be identical to the number of DMRS pairs, or may even be less than the number of DMRS pairs.

In one example, it is assumed that 16 time indices shall be indicated, then 16 cover code sequences need to be found in advance, the cover code sequences being orthogonal or approximately orthogonal to each other. If the cover code sequences are orthogonal to each other, the cover code may be referred to as an orthogonal cover code (OCC) at this moment. A typical example is a Walsh code or a Hadamard code.

Table 1 shows the 16 OCC sequences, which may be denoted as wᵢ(k), i=1 . . . 16, k=1 . . . 16; where, i corresponds to different sequences, corresponding to different columns in Table 1, and k corresponds to different positions in the sequences, corresponding to different rows in Table 1.

TABLE 1

| | | | | | | | | | | | | | | | |
|---|---|---|---|---|---|---|---|---|---|---|---|---|---|---|---|
| 1 | 1 | 1 | 1 | 1 | 1 | 1 | 1 | 1 | 1 | 1 | 1 | 1 | 1 | 1 | 1 |
| 1 | −1 | 1 | −1 | 1 | −1 | 1 | −1 | 1 | −1 | 1 | −1 | 1 | −1 | 1 | −1 |
| 1 | 1 | −1 | −1 | 1 | 1 | −1 | −1 | 1 | 1 | −1 | −1 | 1 | 1 | −1 | −1 |
| 1 | −1 | −1 | 1 | 1 | −1 | −1 | 1 | 1 | −1 | −1 | 1 | 1 | −1 | −1 | 1 |
| 1 | 1 | 1 | 1 | −1 | −1 | −1 | −1 | 1 | 1 | 1 | 1 | −1 | −1 | −1 | −1 |
| 1 | −1 | 1 | −1 | −1 | 1 | −1 | 1 | 1 | −1 | 1 | −1 | −1 | 1 | −1 | 1 |
| 1 | 1 | −1 | −1 | −1 | −1 | 1 | 1 | 1 | 1 | −1 | −1 | −1 | −1 | 1 | 1 |
| 1 | −1 | −1 | 1 | −1 | 1 | 1 | −1 | 1 | −1 | −1 | 1 | −1 | 1 | 1 | −1 |
| 1 | 1 | 1 | 1 | 1 | 1 | 1 | 1 | −1 | −1 | −1 | −1 | −1 | −1 | −1 | −1 |
| 1 | −1 | 1 | −1 | 1 | −1 | 1 | −1 | −1 | 1 | −1 | 1 | −1 | 1 | −1 | 1 |
| 1 | 1 | −1 | −1 | 1 | 1 | −1 | −1 | −1 | −1 | 1 | 1 | −1 | −1 | 1 | 1 |
| 1 | −1 | −1 | 1 | 1 | −1 | −1 | 1 | −1 | 1 | 1 | −1 | −1 | 1 | 1 | −1 |
| 1 | 1 | 1 | 1 | −1 | −1 | −1 | −1 | −1 | −1 | −1 | −1 | 1 | 1 | 1 | 1 |
| 1 | −1 | 1 | −1 | −1 | 1 | −1 | 1 | −1 | 1 | −1 | 1 | 1 | −1 | 1 | −1 |
| 1 | 1 | −1 | −1 | −1 | −1 | 1 | 1 | −1 | −1 | 1 | 1 | 1 | 1 | −1 | −1 |
| 1 | −1 | −1 | 1 | −1 | 1 | 1 | −1 | −1 | 1 | 1 | −1 | 1 | −1 | −1 | 1 |

As the length of the sequence is 16, 16 DMRS pairs in eight RBs at the center of the bandwidth of the synchronization signal need only be used, and other DMRSs within the bandwidth of the synchronization signal may not be used for indicating the time index.

In this example, if the number of the time indices is 16, full indication of the time indices may be carried out in the above example. And if the number of the time indices is 64, the method of this example and the method of Example 1 may be combined, that is, four time indices group are indicated by four DMRS RE position sets by using the method of Example 1, and 16 time indices in a group are indicated by using the method of this Example 2, thereby achieving indication of 64 time indices.

In order to increase the number of time indices indicated by the cover code, increase of a density of the DMRSs may be taken into account, such as using a density of ¼ of the DMRSs. In this way, there exist 72 DMRSs in 12 RBs, and a Hadamard matrix of a dimension of 64×64 may be used to similarly indicate all the 64 time indices. Thereby achieving indication of all 64 time indices only by using the method of Example 2.

With this example, the time indices of the SS blocks may be fully or partially indicated by the cover code on the NR-PBCH DMRSs within the bandwidth of the synchronization signal, that is, it may be defined in the standards that “Time index could be fully or partially indicated by the position of NR-PBCH DMRS RE in SS band”.

An indication method in which this Example 2 and Example 1 are combined to indicate 64 time indices and a method for identifying time indices at a terminal side shall be described below by way of examples of transmission and reception.

At a transmitting end:

The transmitter transmits the original sequence of the NR-PBCH DMRSs multiplexing the OCC.

Here, the original sequence of the NR-PBCH DMRSs is expressed as:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{NR - PBCH} - 1 , \\ {N}_{RB}^{NR - PBCH} = 24 ;$$

where, c(i) is a pseudo-random sequence, as described above, and a cell ID is incorporated into its initial value cᵢₙᵢₜ; however, there exists no information on the number of slots. For example cell, cᵢₙᵢₜ=2N_{ID}^{cell})·2¹⁶; however, it is not limited thereto.

As described above, there are 24 DMRS pairs within the bandwidth of the synchronization signal, and in this example, 16 DMRS pairs at the middle are used to indicate the time indices. And other DMRSs within the bandwidth of the synchronization signal and DMRSs out of the bandwidth of the synchronization signal are unchanged.

In this example, a Hadamard matrix of 16×16 is used to generate an OCC Wᵢ (i=0 . . . 15), as shown in Table 1. In one DMRS pair, only one DMRS is multiplexed with a cover code, and the other DMRS is unchanged.

For example, for a first symbol of a PBCH within the bandwidth of the synchronization signal being n, a second symbol being n+1, a k-th DMRS RE, and a time index of a sequence where the PBCH is located being denoted by an i-th OCC sequence, then,

dmrs′(k,n)=r(k,n)·wᵢ(k);

dmrs′(k,n+1)=r(k,n+1)

where, r(k,n) is an original DMRS sequence. The above DMRS is placed into an RS position set corresponding to the time index, and then is transmitted according to a transmission process of an NR system.

At a receiving end:

Received signals of a DMRS pair may be expressed as:

y(k,n)=h(k,n)·r(k,n)·wᵢ(k)+nₙ(k);

y(k,n+1)=h(k,n+1)·r(k,n+1)+nₙ₊₁(k)

wherein, all noises and interference are denotes as nₙ(k) or nₙ₊₁(k); where, h is a wireless channel response coefficient.

For each DMRS RE position set, a conjugate multiplication may be used to eliminate phase rotation in the channel coefficient h, so as to enable orthogonal identification of the OCC.

dₚ(k)=[y(k,n)·r*(k,n)[ ]y(k,n+1)·r*(k,n+1)]*≈|h(k,n)|²wᵢ(k)+n(k).

In this example, other 8 DMRS pairs within the bandwidth of the synchronization signal may be used to estimate a frequency offset. And in this example, it is assumed that the frequency offset has been compensated before the OCC identification. And during the blind detection, there are total 4 DMRS RE position sets and 16 OCC candidates.

$${M}_{p}^{l} = {\sum }_{k} {d}_{p} ( k ) {w}_{l} ( k ) , k = 0 … 15 , l = 0 … 15 , p = 0 … 3 ;$$

where, p is numbers of all possible DMRS RE position sets, there are 4 possibilities, k corresponds to elements within an OCC sequence, 1 is all possible sequence numbers, and there are 16 possibilities. Hence, there may be 64 detection values for M^{l}ₚ, and a time index may be obtained from the maximum detection value.

In order to ensure a correct detection rate, a peak to average metric is used, which is as the formula below:

$${T}_{idx\_metric} = \frac{\vert {M}_{{p}^{o}}^{{i}^{o}} \vert}{{\sum }_{l , fdm} {M}_{fdm}^{l}} , {i}^{o} , {p}^{o} = {arg max}_{l , fdm} ( \vert {M}_{fdm}^{l} \vert ) .$$

If T_{idx_metric} is greater than a preset threshold, it may be deemed that detected position information and OCC sequence information are correct, and information on a time index of a corresponding SS block may be obtained.

This example may also support combination of multiple synchronization blocks. During a beamforming process, time indices may change in an order of numerals, and such a character may be used for joint detection of combined multiple synchronization blocks. A matrix of three combined synchronization blocks may be expressed as:

$$\overline{{M}_{p}^{l}} = \frac{1}{3} [ {\sum }_{k} {d}_{p}^{ssb 0} ( k ) {w}_{l} ( k ) + {\sum }_{k} {d}_{p}^{ssb 1} ( k ) {w}_{i + 1} ( k ) + {\sum }_{k} {d}_{p}^{ssb 2} ( k ) {w}_{i + 2} ( k ) ] , \\ k = 0 … 15 , l = 0 … 15 , p = 0 … 3 ;$$

where, ssb0 corresponds to an SS block captured in a cell search process of synchronization signals, and ssb1 and ssb2 are latter two possible SS block positions inferred from a time position of ssb0.

One time indices are detected, the matrix |Mₚ_{⁰}ⁱ^{⁰}| may directly be used as a measured value SS-RSRP needed by mobility management, i.e. reference signal received power based on synchronization signals, which is used for management and report of mobility measurement.

### Example 3

In this example, bit information to which time index of an SS block corresponds may be fully or partially coded and modulated, and the modulated symbols are mapped to the RE positions of the NR-PBCH DMRSs within the bandwidth of the synchronization signal, and are taken as the DMRSs of the NR-PBCH, so as to indicate the time index of the SS block. For example, by performing coding, modulating and mapping on full bit information to which the time index correspond, full indication of the time index may be performed. And correspondingly, by performing coding, modulating and mapping on partial bit information to which the time index correspond, partial indication of the time index may be performed. And this example may be used in combination with Example 1 and/or Example 2, or may be used independently.

In this example, at the transmitting end, assuming that the number of time indices of SS blocks needing to be indicated is 64, 6 bits may be used as original information bits, for example, a third sequence may be expressed by the bit information as: 000011, each information bit is repeated for 12 times, and changed into 96 bits. After scrambling (coding), it may be obtained that,

\tilde{b}(i)=(b(i)+c(i))mod 2;

wherein, a cell ID is introduced into the initial value of the pseudo-random sequence which may be expressed as:

cᵢₙᵢₜ=(2N_{ID}^{cell}+1)·2¹⁶.

However, it is not limited thereto.

Thus, the scrambled bit information is modulated into 48 QPSK symbols, which are sequentially mapped onto RE positions of 48 DMRSs of 12 RBs within the bandwidth of the synchronization signal. In this case, symbols on each DMRS pair may be different. In this way, the time index may also be indicated.

The above case is illustrative only. And each bit may also be repeated for 6 times, changed into 48 bits, and modulated to 24 QPSK symbols after being scrambled. In this case, symbols on each DMRS pair are identical. A benefit of such doing is that complexity of detection may be lowered, and is advantageous to frequency offset estimation or frequency offset resistance.

Furthermore, for 6 bits to which 64 time indices correspond, it is possible that 2 bits therein are indicated in other manners, and only 4 bits need to be indicated by forming DMRSs by coding and modulation. That is, partial indication of the time index may be achieved by using the method of this implementation.

In this example, positions of the DMRSs may be fixed, or may be shifted according to the cell ID, as shown in FIG. 8, fdm=CellID/6, or may be indicated by combining with Example 1.

A receiver using this example needs to perform channel estimation by using an SSS, then performs channel equalization, demodulation and decoding on the received DMRSs, and finally obtains information on the time index.

What described above is illustrative only, and in particular implementation, other coding modes, modulation modes and RE mapping modes may also be employed. For example, coding is performed by using a grouping code instead of using repeated coding, and this embodiment is not limited thereto.

In this example, the DMRSs out of the bandwidth of the synchronization signal may following the original DMRS generation mode, such as generating DMRSs based on the following formula; of course, this embodiment is not limited thereto.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{NR - PBCH} - 1.$$

With this example, the information bits of the time index of the SS block may be fully or partially mapped onto the NR-PBCH RE positions within the bandwidth of the synchronization signal after being coded and modulated, that is, it may be defined in the standards that “SSB's time index information bits could be fully or partially coded and modulated to be as RS symbols and mapping to RE position of NR-PBCH DMRS in SS band”.

### Example 4

In this example, multiple low-correlation sequences of lengths equal to the number of the NR-PBCH DMRSs within the bandwidth of the synchronization signal (or a half thereof) corresponding to time indices of different SS blocks may be mapped to the RE positions of the NR-PBCH DMRSs within the bandwidth of the synchronization signal, and taken as the DMRSs of the NR-PBCH, so as to indicate the time indices of the SS blocks. The number of the multiple low-correlation sequences is identical to the number of time indices needing to be indicated, thereby achieving full indication of the time indices. And the number of the multiple low-correlation sequences may also be identical to the number of groups of time indices, and a group of time indices is only indicated, thereby achieving partial indication of the time indices. And this example may be used in combination with Example 1 and/or Example 2 and/or Example 3, or may be used independently.

In this example, other low-correlation sequences, such as a pseudo-random sequence (such as an m sequence), and a constant amplitude zero auto-correlation (CAZAC) sequence, etc., instead of OCC sequences, are used, and a length of each low-correlation sequence may be identical to the number of the REs of the NR-PBCH DMRSs within the bandwidth of the synchronization signal, or may be identical to a half of the number of the REs of the NR-PBCH DMRSs within the bandwidth of the synchronization signal; however, this embodiment is not limited thereto. And furthermore, different low-correlation sequences may correspond to different time indices, and may be taken as the NR-PBCH DMRSs within the bandwidth of the synchronization signal.

With this example, the time indices of the SS blocks may be fully or partially indicated by different low-correlation sequences on the REs of the NR-PBCH DMRSs within the bandwidth of the synchronization signal. For example, it may be defined in the standards that “SSB's time index could be fully or partially indicated by low correlation sequences code sequence mapping to NR-PBCH DMRS RE in SS band”.

The method for indicating the time index of this embodiment is described above by way of four examples. However, as described above, this embodiment is not limited thereto, and any implementations in which NR-PBCH DMRSs within a bandwidth of a synchronization signal are used to indicate time index of the SS block may be contained in the protection scope of this application. And the above four examples may be combined for use in any implementable manners. For example, each group of time indices is indicated by using Example 1, and time indices in each group of time indices are indicated by using Example 2 or 3 or 4.

In this embodiment, in order to increase flexibility of the system, although the maximum number of the SS blocks is 64, the number of actually transmitted SS blocks and corresponding positions are configurable. Hence, other data or control information may be transmitted at positions where no SS block is transmitted.

That is, in this embodiment, when configuration of the synchronization signal blocks is not a default value, the number and positions of actually transmitted SS blocks are transmitted to the terminal equipment, so that the terminal equipment derives possible NR-PBCH DMRS duplicates used for indicating time indices. And such information may be transmitted via RRC signaling. For example, it may be transmitted in a measurement object in a bitmap manner.

By indicating the time index of the synchronization signal block by using the method of this embodiment, the terminal equipment may be enabled to obtain needed timing information.

### Embodiment 2

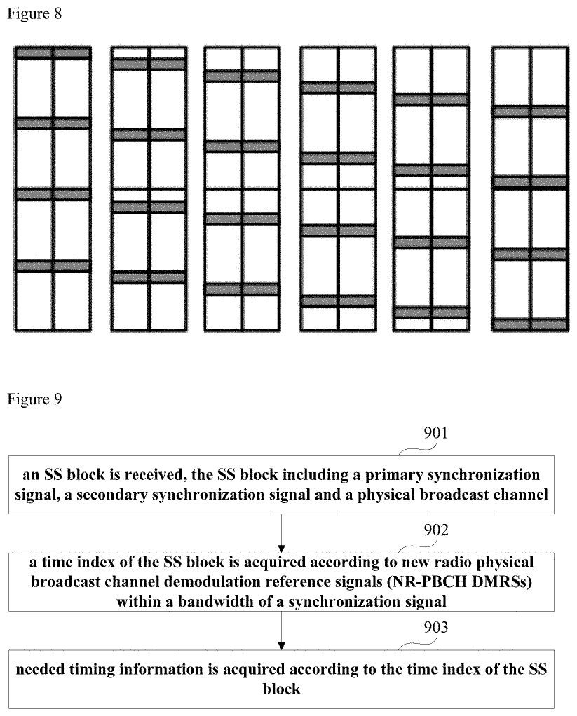

This embodiment provides a timing acquisition method, which is applicable to a terminal equipment in a communication system, such as a UE defined in the NR standards, and is used for detecting the time index of the SS block indicated by a network side by using the method of Embodiment 1, with contents identical to those in Embodiment 1 being not going to be described herein any further. FIG. 9 is a schematic diagram of the method. As shown FIG. 9, the method includes:

step 901: an SS block is received, the SS block including a primary synchronization signal, a secondary synchronization signal and a physical broadcast channel;

step 902: a time index of the SS block is acquired according to new radio physical broadcast channel demodulation reference signals (NR-PBCH DMRSs) within a bandwidth of a synchronization signal; and

step 903: needed timing information is acquired according to the time index of the SS block.

In step 902, the terminal equipment may acquire the time index of the SS block by detecting all DMRS RE positions. As manners for indicating the time index of the SS block are different, methods of detection by the terminal equipment are also different. For example, corresponding to Example 1 in Embodiment 1, the terminal equipment may determine the time index or time index group according to DMRS RE positions only; corresponding to Example 2 in Embodiment 1, the terminal equipment may determine the time index or time index in the time index group in a manner of sequence detection and comparison; corresponding to Example 3 in Embodiment 1, the terminal equipment may determine the time index or time index in the time index group in a manner of decoding; and corresponding to Example 4 in Embodiment 1, the terminal equipment may determine the time index or time index in the time index group in a manner of sequence detection and comparison. And particular implementations shall not be described herein any further.

In step 903, the needed timing information may be SS burst timing information, SS burst set timing information, symbol timing information, mini-slot timing information, slot timing information, or frame timing information to which the SS block corresponds, etc.

Furthermore, a method for obtaining the needed timing information by the terminal equipment according to the time index is not limited in this embodiment. For example, as shown in FIG. 2, the terminal equipment may deduce the symbol timing information according to a starting position of the SS block to which the time index corresponds, deduce the slot timing information or the mini-slot timing information from relative positions of the SS block in the slot or the mini-slot, deduce the SS burst timing information from the position of the SS block to which the time index corresponds in the SS burst, deduce the SS burst set timing information from position of the SS block to which the time index correspond in the SS burst set, and when a period of the SS burst set is greater than or equal to 10 ms, the timing of the SS burst set is the frame timing.

With the method of this embodiment, the network side indicates the time index of the SS block by using the physical broadcast channel demodulation reference signal within the bandwidth of the synchronization signal, and the terminal equipment may obtain related timing information needed by the terminal equipment according to the time index.

### Embodiment 3

The embodiment of this disclosure provides an apparatus for indicating a time index of a synchronization signal block. As principles of the apparatus for solving problems are similar to that of the method of Embodiment 1, reference may be made to implementation of the method of Embodiment 1 for a particular implementation of this apparatus, with identical contents being not going to be described herein any further.

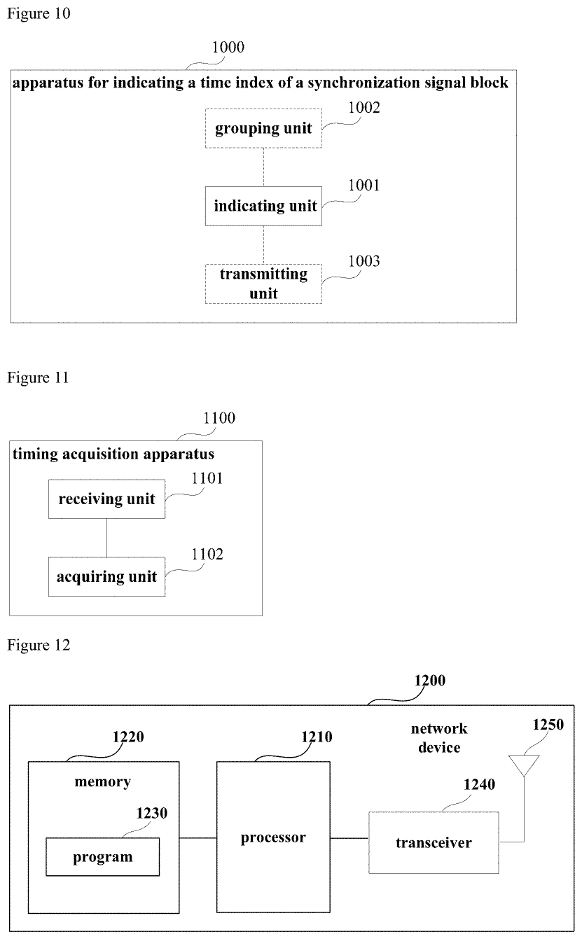

FIG. 10 is a schematic diagram of the apparatus for indicating the time index of the synchronization signal block of this embodiment. As shown in FIG. 10, the apparatus 1000 includes an indicating unit 1001 configured to indicate a time index of an SS block by using physical broadcast channel demodulation reference signals (PBCH DMRSs) within a bandwidth of a synchronization signal, the SS block including a primary synchronization signal, a secondary synchronization signal and a physical broadcast channel.

In this embodiment, the NR-PBCH DMRSs may be DMRSs themselves, or positions where they are located, or DMRSs obtained after other codewords are superposed on original DMRSs.

In this embodiment, the time index of the SS block may be a serial number information of the SS block in an SS burst set, or a time position information of the SS block in an SS burst set, or a serial number information of the SS block in an SS burst, or a time position information of the SS block in an SS burst, or a time position information of the SS block in an SS burst where the SS block is located and a time position information of the SS burst in an SS burst set where the SS burst is located.

In one example of this embodiment, the indicating unit 1001 may fully or partially indicate the time index of the SS block by resource element (RE) positions of the NR-PBCH DMRSs within the bandwidth of the synchronization signal.

In this example, as shown in FIG. 10, the apparatus 1000 may further include a grouping unit 1002 configured to group time indices of all SS blocks within each SS bust set; and the indicating unit 1001 may indicate different time indices or different time index groups by using different RE position sets.

In one example of this embodiment, the indicating unit 1001 may fully or partially indicate the time index of the SS block by a cover code on the NR-PBCH DMRSs within the bandwidth of the synchronization signal.

In this example, the cover code indicates different time indices or different time indices within the same group, and the indicating unit multiplies an original code of the NR-PBCH

DMRSs by the cover code, so as to indicate the different time indices or the different time indices within the same group.

In this example, the cover code is an orthogonal code or an approximately orthogonal code.

In one example of this embodiment, the indicating unit 1001 may include (not shown) a coding and modulating unit, a first mapping unit and a second mapping unit. The coding and modulating unit performs coding and modulating on full or partial bit information to which the time index of the SS block corresponds; the first mapping unit maps symbols modulated by the coding and modulating unit to the RE positions of the NR-PBCH DMRSs within the bandwidth of the synchronization signal, and takes the symbols as the DMRSs of the NR-PBCH; and the first indicating unit indicates the time index of the SS block by using the DMRSs.

In one example of this embodiment, the indicating unit 1001 may include (not shown) a second mapping unit and a second indicating unit. The second mapping unit maps multiple low-correlation sequences of lengths equal to the number of the NR-PBCH DMRSs within the bandwidth of the synchronization signal or a half thereof corresponding to time indices of different SS blocks to the RE positions of the NR-PBCH DMRSs within the bandwidth of the synchronization signal, and takes the sequences as the DMRSs of the NR-PBCH; and the second indicating unit indicates the time index of the SS block by using the DMRSs.

In this embodiment, the bandwidth of the synchronization signal is a bandwidth to which the synchronization signal corresponds, or a bandwidth to which the synchronization signal and its surrounding virtual carriers correspond.

In this embodiment, as shown in FIG. 10, the apparatus 1000 may further include a transmitting unit 1003 configured to, when configuration of the synchronization signal block is not a default value, transmit the actual number and positions of transmitted SS blocks to the terminal equipment, so that the terminal equipment derives possible NR-PBCH DMRSs used for indicating time index.

By indicating the time index of the SS block by the apparatus of this embodiment, the terminal equipment may be enabled to obtain needed timing information.

### Embodiment 4

The embodiment of this disclosure provides a timing acquisition apparatus. As principles of the apparatus for solving problems is similar to that of the method of Embodiment 2, reference may be made to implementation of the method of Embodiment 2 for a particular implementation of this apparatus, with identical contents being not going to be described herein any further.

FIG. 11 is a schematic diagram of the timing acquisition apparatus of this embodiment. As shown in FIG. 11, the apparatus 1100 includes a receiving unit 1101 and an acquiring unit 1102. The receiving unit 1101 receives an SS block, the SS block including a primary synchronization signal, a secondary synchronization signal and a physical broadcast channel; and the acquiring unit 1102 acquires time index of the SS block according to new radio physical broadcast channel demodulation reference signals (NR-PBCH DMRSs) within a bandwidth of a synchronization signal, and acquires needed timing information according to the time index of the SS blocks.

In this embodiment, as described above, the needed timing information may be SS burst timing information, SS burst set timing information, symbol timing information, mini-slot timing information, slot timing information, or frame timing information, etc.

With the apparatus of embodiment, the terminal equipment may be enabled to obtain needed timing information.

### Embodiment 5

The embodiment of this disclosure provides a network device, including the apparatus for indicating a time index of a synchronization signal block as described in Embodiment 3.

FIG. 12 is a schematic diagram of the network device of this embodiment. As shown in FIG. 12, the network device 1200 may include a processor 1210 and a memory 1220, the memory 1220 being coupled to the processor 1210. The memory 1220 may store various data, and furthermore, it may store a program 1230 for data processing, and execute the program 1230 under control of the processor 1210, so as to receive various information transmitted by a terminal equipment, and transmit various information to the terminal equipment.

In one implementation, the functions of the apparatus for indicating a time index of a synchronization signal block may be integrated into the processor 1210. The processor 1210 may be configured to: indicate a time index of an SS block by using new radio physical broadcast channel demodulation reference signals (NR-PBCH DMRSs) within a bandwidth of a synchronization signal, the SS block including a primary synchronization signal, a secondary synchronization signal and a physical broadcast channel.

In another implementation, the apparatus for indicating a time index of a synchronization signal block and the central processor 1210 may be configured separately. For example, the apparatus for indicating a time index of a synchronization signal block may be configured as a chip connected to the processor 1210, with its functions being realized under control of the processor 1210.

Furthermore, as shown in FIG. 12, the network device 1200 may include a transceiver 1240, and an antenna 1250, etc. Functions of the above components are similar to those in the related art, and shall not be described herein any further. It should be noted that the network device 1200 does not necessarily include all the parts shown in FIG. 12, and furthermore, the network device 1200 may include parts not shown in FIG. 12, and the related art may be referred to.

By indicating the time index of the SS block by the network device of this embodiment, the terminal equipment may be enabled to obtain needed timing information.

### Embodiment 6

The embodiment of this disclosure provides a terminal equipment, including the timing acquisition apparatus as described in Embodiment 4.

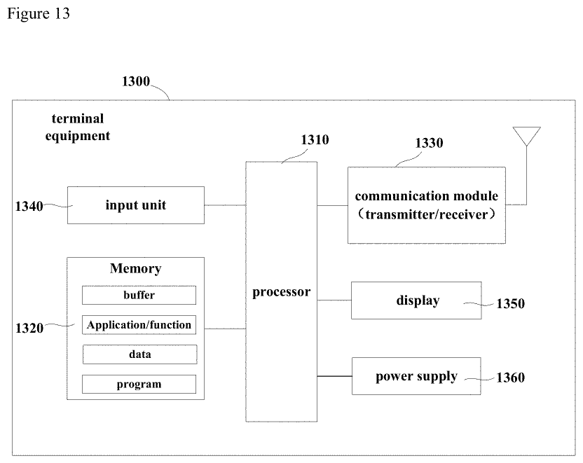

FIG. 13 is a schematic diagram of the terminal equipment of this embodiment. As shown in FIG. 13, the terminal equipment 1300 may include a processor 1310 and a memory 1320, the memory 1320 being coupled to the processor 1310. It should be noted that this figure is illustrative only, and other types of structures may also be used, so as to supplement or replace this structure and achieve a telecommunications function or other functions.

In one implementation, the functions of the timing acquisition apparatus may be integrated into the processor 1310. The processor 1310 may be configured to: receive an SS block, the SS block including a primary synchronization signal, a secondary synchronization signal and a physical broadcast channel, acquire a time index of the SS block according to physical broadcast channel demodulation reference signals within a bandwidth of a synchronization signal, and acquire needed timing information according to the time index of the SS block.

In another implementation, the timing acquisition apparatus and the processor 1310 may be configured separately. For example, the timing acquisition apparatus may be configured as a chip connected to the processor 1310, with its functions being realized under control of the processor 1310.

As shown in FIG. 13, the terminal equipment 1300 may further include a communication module 1330, an input unit 1340, a display 1350, and a power supply 1360. It should be noted that the terminal equipment 1300 does not necessarily include all the parts shown in FIG. 13, and the above components are not necessary; and furthermore, the user equipment 1300 may include parts not shown in FIG. 13, and the related art may be referred to.

As shown in FIG. 13, the processor 1310 is sometimes referred to as a controller or control, which may include a microprocessor or other processor devices and/or logic devices, and the processor 1310 receives input and controls operations of every component of the terminal equipment 1300.

The memory 1320 may be, for example, one or more of a buffer memory, a flash memory, a hard drive, a mobile medium, a volatile memory, a nonvolatile memory, or other suitable devices, which may store the information on configuration, etc., and furthermore, store programs executing related information. And the processor 1310 may execute programs stored in the memory 1320, so as to realize information storage or processing, etc. Functions of other parts are similar to those of the related art, which shall not be described herein any further. The parts of the terminal equipment 1300 may be realized by specific hardware, firmware, software, or any combination thereof, without departing from the scope of the present disclosure.

With the terminal equipment of this embodiment, needed timing information may be obtained.

### Embodiment 7

This embodiment provides a communication system, including the network device as described in Embodiment 5 and a terminal equipment as described in Embodiment 6.

The above apparatuses and methods of this disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams (for example, the indicating unit and the transmitting unit) shown in FIG. 10 may either correspond to software modules of procedures of a computer program, or correspond to hardware modules. Such software modules may respectively correspond to the steps shown in FIG. 5. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for indicating a time index of a synchronization signal block, comprising:
an indicating unit configured to indicate a time index of a synchronization signal block (SS block) by using physical broadcast channel demodulation reference signals (PBCH DMRSs) within a bandwidth of a synchronization signal;
the SS block comprising a primary synchronization signal, a secondary synchronization signal and a physical broadcast channel.

2. The apparatus according to claim 1, wherein the PBCH DMRSs are DMRSs themselves, or positions where they are located, or DMRSs obtained after other codewords are superposed on original DMRSs.

3. The apparatus according to claim 1, wherein the time index of the SS block is a serial number information of the SS block in an SS burst set, or a time position information of the SS block in an SS burst set, or a serial number information of the SS block in an SS burst, or a time position information of the SS block in an SS burst, or is jointly given by a time position information of the SS block in an SS burst where the SS block is located and a time position information of the SS burst in an SS burst set where the SS burst is located.

4. The apparatus according to claim 1, wherein the indicating unit fully or partially indicates the time index of the SS block by resource element (RE) positions of the PBCH DMRSs within the bandwidth of the synchronization signal.

5. The apparatus according to claim 4, wherein the apparatus further comprises:
a grouping unit configured to group time indices of all SS blocks within each SS bust set;
and the indicating unit indicates different time indices or different time index groups by using different RE position sets.

6. The apparatus according to claim 1, wherein the indicating unit fully or partially indicates the time indices of the SS blocks by a cover code on the PBCH DMRSs within the bandwidth of the synchronization signal.

7. The apparatus according to claim 6, wherein the cover code indicates different time indices or different time indices within the same group, and the indicating unit multiplies an original code of the PBCH DMRSs by the cover code, so as to indicate the different time indices or the different time indices within the same group.

8. The apparatus according to claim 7, wherein the cover code is an orthogonal code or an approximately orthogonal code.

9. The apparatus according to claim 1, wherein the indicating unit comprises:
a coding and modulating unit configured to perform coding and modulating on full or partial bit information to which time indices of SS blocks correspond;
a first mapping unit configured to map symbols modulated by the coding and modulating unit to the RE positions of the PBCH DMRSs within the bandwidth of the synchronization signal, and take the symbols as the DMRSs of the PBCH; and
a first indicating unit configured to indicate the time index of the SS block by using the DMRS s.

10. The apparatus according to claim 1, wherein the indicating unit comprises:
a second mapping unit configured to map multiple low-correlation sequences of lengths equal to the number of the PBCH DMRSs within the bandwidth of the synchronization signal or a half thereof corresponding to time indices of different SS blocks to the RE positions of the PBCH DMRSs within the bandwidth of the synchronization signal, and take the sequences as the DMRSs of the PBCH; and
a second indicating unit configured to indicate the time index of the SS block by using the DMRS s.

11. The apparatus according to claim 1, wherein the bandwidth of the synchronization signal is a bandwidth to which the synchronization signal corresponds, or a bandwidth to which the synchronization signal and its surrounding virtual carriers correspond.

12. A timing acquisition apparatus, comprising:
a receiving unit configured to receive an SS block, the SS block comprising a primary synchronization signal, a secondary synchronization signal and a physical broadcast channel; and
an acquiring unit configured to acquire time index of the SS block according to physical broadcast channel demodulation reference signals (PBCH DMRSs) within a bandwidth of a synchronization signal, and acquire needed timing information according to the time index of the SS block.

13. The apparatus according to claim 12, wherein the needed timing information is any one of the following or a combination thereof: SS block timing, SS burst timing, SS burst set timing, frame timing, symbol timing of an SS block, slot timing, and mini-slot timing.

14. A communication system, comprising a network device and a terminal equipment, the network device comprising: an apparatus for indicating a time index of a synchronization signal block, comprising:
an indicating unit configured to indicate a time index of a synchronization signal block (SS block) by using physical broadcast channel demodulation reference signals (PBCH DMRSs) within a bandwidth of a synchronization signal;
the SS block comprising a primary synchronization signal, a secondary synchronization signal and a physical broadcast channel; and
the terminal equipment comprising: a timing acquisition apparatus, comprising:
a receiving unit configured to receive an SS block, the SS block comprising a primary synchronization signal, a secondary synchronization signal and a physical broadcast channel; and
an acquiring unit configured to acquire time index of the SS block according to physical broadcast channel demodulation reference signals (PBCH DMRSs) within a bandwidth of a synchronization signal, and acquire needed timing information according to the time index of the SS block.
